(19) United States
(12) Patent Application Publication
(10) Pub. No.: US 2024/0307858 A1
(43) Pub. Date: Sep. 19, 2024

(54) TRI-FUNCTIONAL HETEROGENEOUS PHOTOCATALYST

(71) Applicant: THE GOVERNING COUNCIL OF THE UNIVERSITY OF TORONTO, Toronto (CA)

(72) Inventors: Alexandra Victoria TAVASOLI, Toronto (CA); Geoffrey Alan OZIN, Toronto (CA)

(21) Appl. No.: 18/572,364

(22) PCT Filed: Jun. 29, 2022
(86) PCT No.: PCT/CA2022/051039

§ 371 Date: Dec. 20, 2023

Related U.S. Application Data
(60) Provisional application No. 63/216,668, filed on Jun. 30, 2021.

(51) Int. Cl. B01J 27/185; B01J 35/39; B01J 35/45

(52) U.S. Cl. CPC B01J 27/1856; B01J 35/39; B01J 35/45

(57) ABSTRACT

A three-phase heterogeneous photocatalyst composition is provided for catalysing dry reforming reactions. The photocatalyst composition is comprised of a photochemically active component, a photothermal component, and a plasmonic material that function synergistically to catalyze dry reforming reactions.

### FIELD

The present disclosure generally relates to the field of photocatalysis and in particular a heterogeneous photocatalyst having three functions that operate synergistically.

### BACKGROUND

A photocatalyst is a catalyst able to produce, upon absorption of light, chemical transformations of the reaction partners. Photocatalysis is the change in the rate of a chemical reaction or its initiation under the action of ultraviolet, visible, or infrared radiation in the presence of a substance—the “photocatalyst”—that absorbs light and is involved in the chemical transformation of the reaction partners. One pathway through which absorption of incident radiation can affect the rate of the reaction is through the production of either or both an excited electronic state or plasmonic resonance effect that repeatedly interacts with the reaction partners forming reaction intermediates and facilitates an overall chemical reaction, termed “photochemical” or “plasmonic” activity, respectively. Another pathway through which absorption of incident radiation affects the rate of reaction is through the production of heat at the surface of the photocatalyst, termed “photothermal” activity.

There are several dry reforming photocatalysts that have been presented in the academic literature having high rates of activity and coking resistance. However, these beneficial attributes have been limited to catalysts that take advantage of the intrinsic coke-resistant properties of noble metals. To avoid the use of expensive catalytic materials, Ni-based catalysts have been the dominant alternative to noble metals for dry reforming, as noble metals are often too costly to justify their use in synthesis gas production. As a result, it follows that a viable noble metal-free dry reforming catalyst would require that its resistance to carbon deposition should be sourced from a different feature of the catalyst other than the intrinsic properties of noble metals.

Accordingly, improved photocatalysts are needed for catalysing dry reforming reactions that do not involve expensive noble metals.

### SUMMARY

In one aspect, there is provided a photocatalyst composition for catalysing a dry reforming reaction, wherein the photocatalyst composition is a three-phase heterogeneous catalyst comprising: a) a support composition comprising a first component and a second component, wherein the first and second components each exhibit photochemical and/or photothermal activity when irradiated; and b) a plasmonic material on the surface of the support composition and in contact with the support composition. The first component is a metal oxide, the second is a metal phosphate or phosphide, preferably a metal phosphate.

In another aspect, there is provided a method of performing a dry reforming reaction, the method comprising: introducing molecular reactants into contact with the photocatalyst composition described herein, and exposing the photocatalyst composition to incident radiation with a light source.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments of compounds and methods are described throughout reference to the drawings.

FIG. 1 shows the SEM-EDX results of a bulk catalyst sample of Ni—CeO₂—CePO₄. Scale bar denotes 50 μm.

FIG. 2 shows a bar graph of the effect of different CePO₄ to CeO₂ ratio (P:Ce) of the support composition on the photocatalyst activity.

FIG. 3 shows A) activity of Ni—P:Ce-0.65 catalyst (denoted as the “actual” mol ratio pf P:Ce measured using SEM-EDX shown in FIG. 1, corresponding to the synthesis carried out at a theoretical P:Ce ratio of 0.5) at varying reactor temperatures and under varying light irradiance (each set of 8 bars are presented in the same order as listed in the legend), and B) infrared camera temperature of Ni—P:Ce-0.65 catalyst at varying reactor temperatures and under varying light irradiance.

FIG. 4 shows the effect of varying wavelength-specific intensities on photocatalytic rate.

FIG. 5 shows a comparison of Ni—P:Ce-0.65 catalyst activity against other nickel-based dry reforming catalysts.

FIG. 6 shows (A) Graphical schematic of the Ni—CeO₂—CePO₄ photocatalyst under study. (B) Scanning electron microscope of Ni—CeO₂—CePO₄. (C) Activity towards the dry reforming reaction at varying reactor temperatures and light intensities (each set of 8 bars are presented in the same order as listed in the legend). (D) 8-hour stability under optimized conditions that result in stoichiometric conversion. (E) Equilibrium product composition of dry reforming reaction system at varying temperatures. (F) Thermal activity of Ni—CeO₂—CePO₄ photocatalyst at 350° C. with varying support compositions (x axis noted in mol ratio used in the synthesis, actual mol ratios from SEM-EDX are noted in FIG. 1).

FIG. 7 shows (A) XRD spectra of Ni—CeO₂—CePO₄ photocatalyst with theoretical P:Ce ratio of 0.5, see FIG. 1. (B) Surface partitioning of phosphorous-containing phase, see FIG. 9 and FIG. 1 for XPS and EDX spectra, respectively. (C) TGA CO₂ uptake for photocatalyst with varying support composition. (D) BET surface area measurements of photocatalyst with varying support composition (each set of 3 bars are presented in the same order as listed in the legend). (E) Temperature of photocatalyst under varying irradiance and reactor temperature.

FIG. 8 shows wavelength and irradiance dependence of photocatalytic activity of Ni—CeO₂—CePO₄ dry reforming photocatalyst. Bottom 2 graphs: UV-vis spectra of photocatalyst varying compositions

FIG. 9 shows the composition of the surface of the three-component photocatalyst via XPS and energy-dispersive x-ray spectroscopy (EDX). In the top graph, the vertical order of each spectra correspond to the vertical order of the legend. A) B) C) all represent zoomed-in portions of the spectra that are relevant to the Ce, P, and O oxidation states present at the surface of the photocatalyst.

FIG. 10 shows thermogravimetric analysis showing the difference in CO₂ uptake by the catalyst supports with different ratios of phosphate to oxide.

FIG. 11 shows in-situ DRIFTS spectra measured during DRM reaction over the 10% Ni—CeO₂—CePO₄ catalyst under light and dark conditions at 350° C.

FIG. 12 shows A) dry reforming equilibrium composition of the product gas mixture. B) the CO₂ uptake by photocatalysts with varying support composition, measured by thermogravimetric analysis. C) shows the surface area of the photocatalyst material with varying compositions (each set of 3 bars are presented in the same order as listed in the legend). D) the catalyst temperature under different irradiances of light, and heated reactor temperatures

### DETAILED DESCRIPTION

Carbon dioxide reforming, or dry reforming, is a method of producing synthesis gas (mixtures of hydrogen and carbon monoxide) from the reaction of carbon dioxide with hydrocarbons such as methane (Formula I). Thus, two greenhouse gases are consumed and useful chemical building blocks, hydrogen and carbon monoxide, are produced.

CO₂+CH₄→2H₂+2CO (I)

The present disclosure provides an improved photocatalyst for catalyzing dry reforming reactions. It was discovered that the change in the rate of the dry reforming reaction when the photocatalyst is illuminated with light results from several interrelated and synergistic photo-induced phenomena: plasmonic resonance, photochemical activity, and photothermal activity. Hence, providing a heterogeneous photocatalyst comprised of three components that induce plasmonic resonance, photochemical activity, and photothermal activity simultaneously, allows for an improved photocatalyst for catalyzing dry reforming reactions based on the synergy of the three components. The effect exhibited by the photocatalyst depends primarily on the electronic structure of the photocatalyst material, and the energy of the incident radiation that is absorbed.

In some embodiments, a photocatalyst composition for catalysing a dry reforming reaction comprises three components that together form a three-phase heterogeneous catalyst material. In some embodiments, two or three components of the three-phase heterogeneous catalyst material exhibit photochemical or photothermal activity, or both photochemical and photothermal activity In some embodiments, the three components are a photochemically active component, a photothermal component, and a plasmonic material. As used herein, a “photochemically active component” refers to compounds or materials capable of exhibiting photochemical activity. A photochemically or plasmonically active component may additionally exhibit photothermal activity upon irradiation. As used herein, a “photothermal component” refers to compounds or materials capable of exhibiting photothermal activity. A photothermal component may additional exhibit photochemical activity upon irradiation. As used herein, a “plasmonic material” refers to compounds or materials capable of exhibiting plasmonic resonance. The three phases of the photocatalytic material have distinct mechanistic responses when illuminated with light. The responses of each of the three phases affect the response of the other phases.

Plasmonic effects are where light absorption gives rise to a strong, localized, electromagnetic field which increases light absorption around a catalyst nanostructure. Heat can also be generated by non-plasmonic materials through intraband and interband electronic transitions to provide photothermal activity.

Photochemical activity, in contrast, appears in semiconductor materials with a suitable band gap, which will absorb the portion of incident light that has photons with energies greater than the band gap energy of the semiconductor, which results in an electronic excitation and a resulting excited state of the material that absorbed the photon. The excited state can then facilitate the chemical reaction at hand through a new and potentially lower energy pathway.

The presence of plasmonic effects that result upon light absorption increases light absorption around a photocatalyst nanostructure, which can enhance light absorption in the other components of the photocatalyst, and simultaneously provide some elevated temperature that can enhance the reaction rate. Similarly, photothermal component heats up under light absorption, and increases the reaction rate by raising the reaction temperature.

Therefore, these two effects of increasing light absorption and reaction temperature have a beneficial and synergistic effect on the photochemically active component. By heating up the semiconductor, the band gap size decreases, which indicates that a larger portion of the solar spectrum can be used to create an excited state. As a result, the three components of the photocatalyst can work synergistically to improve the overall reaction rate.

In some embodiments, a three-phase heterogeneous photocatalyst composition for catalysing a dry reforming reaction comprises 1) a support composition comprising a first component and a second component, wherein the first and second components each exhibit photochemical and/or photothermal activity when irradiated and 2) a plasmonic material disposed on the surface of the support composition and in contact with the support composition. The first component is a metal oxide, while the second component is a metal phosphate or phosphide, preferably a metal phosphate.

As used herein, “contact” includes mechanical material contact, chemical bonding, physical attractions through mechanical contact, or electrical coupling.

In one embodiment, the first component is a photochemically active component and the second component is a photothermal component. In one embodiment, the second component is a photochemically active component and the first component is a photothermal component. In one embodiment, the first and second components each exhibit both photochemical and photothermal activity when irradiated. Different wavelengths of incident irradiation can trigger different responses. In one embodiment, one of the first and second components exhibits both photochemical and photothermal activity, while the other component exhibits photochemical activity. In one embodiment, one of the first and second components exhibits both photochemical and photothermal activity, while the other component exhibits photothermal activity.

It was discovered that the ratio of the phosphate to oxide in the support composition is important in maximizing the photocatalyst's performance towards dry reforming reactions. In some embodiments, the molar ratio of the metal phosphate or phosphide to the metal oxide is in a range of 0.1-0.9, preferably 0.1-0.75, preferably 0.25-0.75, preferably 0.3-0.7, preferably 0.4-0.7, preferably 0.45-0.65, or more preferably 0.48-0.65. In one embodiment, the ratio of the metal phosphate or phosphide to the metal oxide is about 1:1.

In some embodiments, a first component (such as a photochemically active component, or a material that exhibits both photochemical and photothermal activity upon irradiation) is a metal oxide having a high surface basicity and/or is photoactive. In some embodiments, a photochemically active component is a Group 2 metal oxide, or a rare earth metal oxide. In some embodiments, the photochemically active component is a magnetic material, or a semiconductor material.

In some embodiments, the first component is a metal oxide such as MgO, CaO, BaO, La₂O₃, ThO₂, CeO₂, ZrO₂, TiO₂, ZnO, SnO₂, Y₂O₃, Bi₂O₃ or In₂O₃. In one embodiment, the photochemically active component is MgO, CeO₂, ZrO₂, or In₂O₃.

In some embodiments, a second component (such as a photothermal component, or a material that exhibits both photochemical and photothermal activity upon irradiation) is a metal phosphate or phosphide, such as Group 2 metal phosphate or phosphide, or a rare earth metal phosphate or phosphides, preferably a Group 2 metal phosphate or rare earth metal phosphate. In some embodiments, a photothermal component is a magnetic material.

In some embodiments, the second component is a magnesium phosphate (i.e. Magnesium dihydrogen phosphate: Mg(H₂PO₄)₂ Magnesium hydrogen phosphate: Mg(HPO₄), Trimagnesium phosphate: Mg₃(PO₄)₂), or hydrates thereof) or a magnesium phosphide (i.e. Mg₃P₂). In some embodiments, the second component is a calcium phosphate (i.e. Calcium dihydrogen phosphate: Ca(H₂PO₄)₂, Calcium hydrogen phosphate: Ca(HPO₄) Tricalcium phosphate (calcium phosphate): Ca₃(PO₄)₂, Octacalcium phosphate: Ca₈H₂(PO₄)₆, Calcium hydroxyphosphate Ca₁₀(PO₄)₆(OH)₂, Dicalcium diphosphate: Ca₂P₂O₇, Calcium triphosphate: Ca₅(P₃O₁₀)₂, or hydrates thereof) or a calcium phosphide (i.e. Ca₃P₂). In some embodiments, the second component is a barium phosphate (i.e. Ba₃(PO₄)₂) or a barium phosphide (i.e. Ba₃P₂). In some embodiments, the second component is a lanthanum phosphate (i.e. LaPO₄) or a lanthanum phosphide (i.e. LaP). In some embodiments, the second component is a thorium phosphate (i.e. Thorium phosphate-diphosphate: Th₄(PO₄)₄P₂O₇) or a thorium phosphide (Th₃P₄). In some embodiments, the second component is a cerium phosphate (i.e. CePO₄) or a cerium phosphide (CeP). In some embodiments, the second component is a zirconium phosphate (i.e. ZrPO₄, Zr₃(PO₄)₄, Zr(HPO₄)₂ or hydrates thereof) or a zirconium phosphide (i.e. ZrP). In some embodiments, the second component is a titanium phosphate (i.e. Ti₃(PO₄)₄) or a titanium phosphide (i.e. TiP). In some embodiments, the second component is a zinc phosphate (i.e. Zn₃(PO₄)₂) or a zinc phosphide (i.e Zn₃P₂). In some embodiments, the second component is a tin phosphate (i.e. Sn₃(PO₄)₄) or a tin phosphide (i.e. Tin Monophosphide: SnP, or Tin (IV) Phosphide: Sn₄P₃). In some embodiments, the second component is an indium phosphate (i.e. InPO₄) or an indium phosphide (InP). In other embodiments, the second component may be any other phosphorous-containing inorganic compound.

In one embodiment, the second component is Mg₃(PO₄)₂, CePO₄, ZrPO₄, or InPO₄.

In some embodiments, the plasmonic material also exhibits photochemical and/or photothermal activity when irradiated.

In some embodiments, a plasmonic material is a Group 8 metal, a Group 11 element, a noble metal. In some embodiments, the plasmonic material is Au, Ag, or Cu. In other embodiments, the plasmonic material is aluminum, cadmium, chromium, copper, iron, lead, nickel, tin, or zinc. In some embodiments, the plasmonic material is in general any metal or metalloid element on the Periodic Table of the Elements and alloys including said elements. In one embodiment, the plasmonic material is nickel. Further examples of a plasmonic material can be found in United States Patent Publication No. 20210023541A1, the entire content of which is incorporated herein by reference.

In one embodiment, a photocatalyst composition for catalysing a dry reforming reaction has the three components or phases described herein where the photochemically and/or photothermally active component is CeO₂ or CePO₄, and the plasmonic material is Ni. In one embodiment, the photocatalyst composition comprises CeO₂, CePO₄ and Ni.

In one embodiment, a photocatalyst composition for catalysing a dry reforming reaction has the three components or phases described herein where the photochemically and/or photothermally active component is MgO or Mg₃(PO₄)₂, and the plasmonic material is Ni. In one embodiment, the photocatalyst composition comprises MgO, Mg₃(PO₄)₂ and Ni.

In one embodiment, a photocatalyst composition for catalysing a dry reforming reaction has the three components or phases described herein where the photochemically and/or photothermally active component is In₂O₃ or InPO₄, and the plasmonic material is Ni. In one embodiment, the photocatalyst composition comprises In₂O₃, InPO₄ and Ni.

In one embodiment, a photocatalyst composition for catalysing a dry reforming reaction has the three components or phases described herein wherein the photochemically and/or photothermally active component is ZrO₂ or ZrPO₄, and the plasmonic material is Ni. In one embodiment, the photocatalyst composition comprises ZrO₂, ZrPO₄ and Ni.

In some embodiments, the plasmonic material is disposed in clusters on the surface of the support composition. In some embodiments, the clusters have a diameter size of 1-1000 nm, 1-500 nm, 1-100 nm, 1-50 nm, or 5-20 nm.

In some embodiments, the photocatalyst composition has a nanoparticle structure. For example, the support composition are spherical or irregular nanoparticles, with plasmonic material disposed in clusters on its surface. In other embodiments, the photocatalyst composition has a nanorod structure. For example, the support composition are nanorods, with plasmonic material disposed in clusters on its surface. In yet other embodiments, the photocatalyst composition has a nanostructure. For example, the support composition are nanofilms, nanochains, nanofoams, nanoholes, nanomeshes, nanoribbons, nanosheets, or nanowires, with plasmonic material disposed in clusters on its surface.

In some embodiments, the photocatalyst composition is manufactured by aqueous-based chemical synthesis, incipient wetness, solid-state syntheses, radiation-dependent syntheses, or crystallization. In one embodiment, the photocatalyst composition is manufactured by chemical or physical vapor deposition. Other methods of manufacture are available and readily appreciated by a skilled person in the art.

When catalyzing a dry reforming reaction, molecular reactants (carbon dioxide and methane gas) are introduced into contact with the photocatalyst composition described herein, and the photocatalyst composition is illuminated with light. In some embodiments, the photocatalyst composition is illuminated with UV, blue, and/or green light. In some embodiments, the light is provided by a light source such as but not limited to electrically-driven lamps, or natural sunlight.

Numerous details are set forth to provide an understanding of the examples described herein. The examples may be practiced without these details. The description is not to be considered as limited to the scope of the examples described herein.

### EXAMPLES

The following examples illustrate certain embodiments addressing specific design requirements and are not intended to limit the embodiments described elsewhere in this disclosure.

### Example 1—Ni—CeO₂—CePO₄ Heterostructure for Catalyzing Dry Reforming Reactions

A novel dry reforming catalyst comprised of a Ni—CeO₂—CePO₄ heterostructure is presented. The catalyst, which is structured as nickel nanoparticles supported on a mixed CeO₂CePO₄ nanorod support, is shown to exhibit sufficiently high activity and stability towards the dry reforming reaction to meet the performance requirements necessary for industrial adoption.

The main sources of dry reforming catalyst deactivation that are relevant to the present discussion are thermal degradation and carbon deposition. Thermal degradation can occur if the catalyst suffers a reduction in activity due to a thermally-induced change in the catalyst material, which often leads to a reduction in catalyst surface area, either through metal particle sintering that leads to poor metal dispersion on the catalyst support, or through loss of support surface area. Carbon deposition and accumulation on the surface of dry reforming catalysts can originate from either the CH₄ or CO₂ reactant species, and can lead to poisoning or fouling of the catalyst surface, which can lead to deactivation.

Carbon deposition originating from CH₄ reactant species has been shown to occur as the result of a stepwise CH₄ decomposition. The academic literature describing the dry reforming reaction mechanism over Ni-based catalysts in conventional thermally driven systems indicates that the CH₄ reactant preferentially adsorbs to the Ni sites on the catalyst. This can lead to carbon deposition on the metal surface by virtue of a step-wise decomposition of the CH₄ molecule through the dissociation of H atoms from the molecule to produce adsorbed CHₓ and H fragments. The H atoms may subsequently be shuttled away from their initial adsorption site on the metal and onto the support, through the phenomenon of “hydrogen spillover” where they may react with other adsorbed species. If all of the H's are shed from the adsorbed CHₓ complex (ie. x=4), then a C atom remains.

Similarly, carbon deposition from CO₂ takes place via the decomposition of surface-adsorbed CO species that originate from the dissociative adsorption of CO₂ on a transition metal surface. This process, called “CO disproportionation” (2CO≈C_{gr}+CO₂) is thought to occur preferentially when CO is adsorbed to a multiply coordinated metal site, which leads to the CO molecule adsorbing through a bent transition state where the molecule essentially lies parallel to the surface of the catalyst prior to dissociation.

The carbon that is left behind on the Ni surface through both the CH₄ or CO₂ pathway has been shown to subsequently diffuse through the Ni to the Ni-support interface, separating the metal from the support, and negating any metal-support interactions that may have existed, and ultimately leading to catalyst deactivation. The driving force for C diffusion through the Ni is primarily thermal, and as such can be influenced by the presence of surface chemical reactions (or photon induced mechanisms) that are exothermic.

The mixed phase CeO₂—CePO₄ photocatalyst support takes advantage of two strategies to prevent carbon accumulation and resulting catalyst activity loss. First, supports with high oxygen storage capacity have been shown to be able to effectively react surface oxygen species with adsorbed carbon atoms to oxidize the surface CHₓ species so as to avoid the deposition of solid carbon on the surface of the catalyst. The CeO₂ component of the Ni—CeO₂—CePO₄ presented here it is well known to have intrinsic oxygen storage capacity properties as a result of the Ce³⁺/Ce⁴⁺ redox couple, which enables the material to facilitate the rapid exchange of surface oxygen with gas phase species due to a high diffusion rate of bulk oxygen towards the surface. The accumulation of carbon on the surface then becomes a function of the relative kinetics of the system, specifically the speed at which surface C is formed, with respect to the speed at which it can be oxidized, which in turn depends on the availability of oxygen at the surface of the CeO₂ support, as well as the rate at which carbon diffuses through the Ni metal cluster to the metal-support interface. In addition, oxygen vacancies present can allow for the diffusion of O atoms into the catalyst lattice from adsorbed CO₂.

Second, C deposition can be prevented by controlling the Ni metal cluster size on the catalyst and increasing CO₂ adsorption in the reactant system, which can both be accomplished through the use of catalyst supports with high Lewis basicity. Minimizing the Ni-cluster size on the support limits the number of multiply-coordinated metal sites, which in turn limits the number of Ni sites available for either the stepwise CH₄ decomposition, or for an adsorbed CO moiety to enter a bent transition state. Small metal cluster size will also facilitate a closer proximity to support adsorbed moieties for a potential reaction to take place. Basic supports have been shown to improve metal dispersion and therefore facilitate a smaller metal cluster size because the Lewis basic surface has a high number of non-bonding electrons available to attract and strongly disperse positively charged metal ions, leading to a two-pronged benefit for preventing carbon deposition from both CHₓ degradation and CO₂ decomposition. The acidic or basic nature of the catalyst support surface depends on the properties of the metal, including charge, coordination number, size, and electronegativity.

The basic catalyst surface has the additional ability to strongly adsorb the acidic CO₂ molecule to the surface. The increased surface concentration of CO₂ occupies surface adsorption sites, thereby blocking sites for decomposition products that lead to carbon deposition to adsorb to. This can provide favourable conditions for high selectivity towards the main dry reforming reaction, since the presence of excess CO₂ in the reaction system decreases the amount of C expected at thermal equilibrium. Having excess CO₂ adsorb to a basic support can help this.

The use of cerium orthophosphate (CePO₄) in the photocatalyst support serves to solve this issue. The Lewis basic PO₄³-groups improve CO₂ adsorption, in addition to the aforementioned ability to facilitate the formation of small metal clusters on the support surface.

In addition to the advantageous chemical characteristics of the Ni—CeO₂—CePO₄ dry reforming catalyst described above, the three components of the catalyst have optical properties that make it an attractive potential photocatalyst. CePO₄ is a UV- and blue-light absorber used in modern sunscreens, with a similar bandgap to that of CeO₂, reported in the 3.2-3.5 eV range. Nickel is also known to absorb light in the UV and visible range by virtue of interband electronic transitions and plasmonic resonance, respectively, with Ni intraband transitions causing absorption in the near infrared and visible regions, in turn giving rise to the black appearance of the Ni-loaded catalyst. Further, the presence of defects in the catalyst lattice, such as oxygen vacancies and resulting Ce³⁺ state. Excited states caused by photon absorption, can give rise to mid-band gap or excited states that can further alter the electronic configuration and optical properties of the photocatalyst, and therefore its chemical behaviour as a catalyst. Finally, CePO₄ also has thermal and chemical stability under reaction conditions.

Below, the structural and optical properties of the Ni—CeO₂—CePO₄ photocatalyst samples under consideration are described, followed by a description of the experimental approach taken to develop the catalyst material. A set of photocatalyst samples with varying CePO₄ to CeO₂ (P:Ce) ratios in the support are tested thermally. It is found that an optimum catalyst composition exists with respect to the P:Ce ratio in the support. This optimal P:Ce ratio of 0.65 was then used to determine the reactor temperature and light illumination conditions required to achieve a high selectivity towards the main dry reforming reaction, and not towards the side RWGS reaction. The wavelength dependency of the photocatalyst activity is also probed. Finally, the stability of the catalyst over an 8 hour period is evaluated. The Ni—CeO₂—CePO₄ photocatalyst described herein is shown to achieve activities appropriate for industrial adoption, as well as good stability and coking resistance, and superior performance in comparison to other Ni-based, precious metal-free dry reforming photocatalysts that have been reported in the academic literature. In conclusion, ways in which the catalyst can be further optimized are described, and requirements for implementing the photocatalyst into a scaled reactor system are reviewed.

### Example 2—Synthesis, Characterization, and Experimental Methods

Synthesis. The Ni—CeO₂—CePO₄ photocatalyst was produced by first synthesizing a mixed CeO₂CePO₄ support using an aqueous room temperature synthesis adapted from Zeng et al., followed by the addition of Ni to the structure using the incipient wetness technique. An amount of Ce(NO₃)₃·H₂O (99% pure, trace metals basis) was dissolved into deionized water, and a stoichiometrically appropriate amount of H₃PO₄ (85 wt %) was added to the solution, at an amount that reflects the percentage of the dissolved cerium that is intended to form CePO₄. The balance of the Ce ions convert to CeO₂ in the process. Ammonia was then added drop-wise until the pH of the solution reached 9. The mixture was then stirred at room temperature for 2 hours, and aged at room temperature for an additional 24 hours.

The resulting product solution was then centrifuged and washed with deionized water repeatedly until the pH of the supernatant liquid reached 7. The separated powder samples were then dried at 80° C. in air, and then calcined for 3 hours at 450° C. Ni was loaded onto the support via an aqueous Ni(NO₃)₂ solution using the incipient wetness technique, followed by calcination for 3 hours at 450° C. The samples were then reduced at 650° C. under a 10% H₂/Ar mixture for 3 hours.

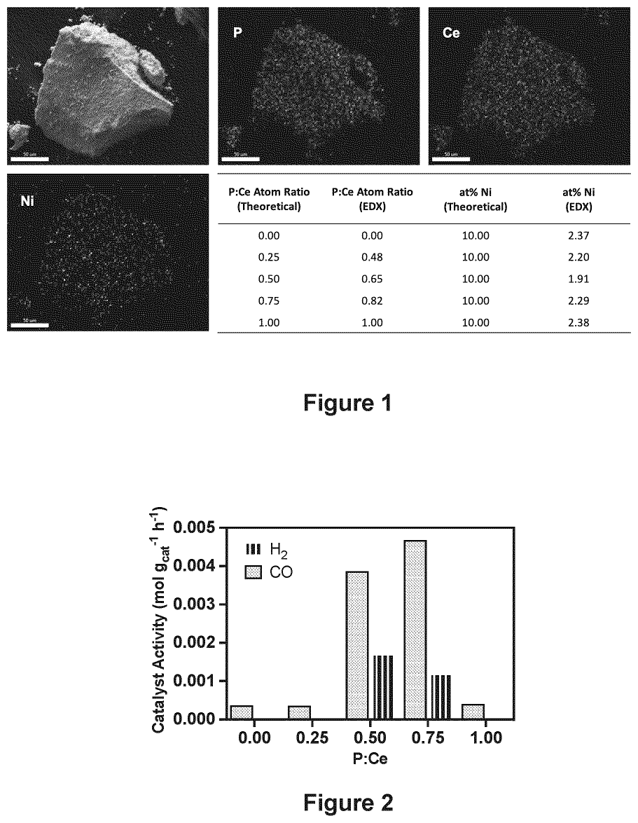

SEM and EDX analysis. An FEI Quanta FEG 250 scanning electron microscope equipped with STEM and EDAX detectors was used to determine the structure and composition of the resulting Ni—CeO₂—CePO₄ catalysts with varying support compositions. FIG. 1 and Table 1 shows that the P, Ce, and Ni signals are well dispersed in the sample. Further, the catalyst compositions measured by EDX indicate an average Ni loading of 2.23 at %. The samples will be referred to by their support composition, as P:Ce-x.xx where x.xx indicates the P:Ce ratio indicated in FIG. 1 and Table 1, either by the theoretical ratio that was used in the synthesis, or by the corresponding actual ratio that was measured using EDX. As such, the samples under consideration are P:Ce-0.00, P:Ce-0.48, P:Ce-0.65, P:Ce-0.82, and P:Ce-1.00. The catalyst support samples P:Ce were subjected to final high temperature reduction step of the catalyst synthesis.

TABLE 1
SEM-EDX results of bulk catalyst sample

| P:Ce Atom Ratio | P:Ce Atom Ratio | at % Ni | at % Ni |
|---|---|---|---|
| (Theoretical) | (EDX) | (Theoretical) | (EDX) |
| 0.00 | 0.00 | 10.00 | 2.37 |
| 0.25 | 0.48 | 10.00 | 2.20 |
| 0.50 | 0.65 | 10.00 | 1.91 |
| 0.75 | 0.82 | 10.00 | 2.29 |
| 1.00 | 1.00 | 10.00 | 2.38 |

X-ray diffraction. X-ray diffraction was carried out on a Bruker D2-Phaser X-ray diffractometer using Cu Kα radiation generated at 30 kV. The P:Ce-0.00 sample showed peaks indicative of the fluorite CeO₂ crystal structure, and a Ni[111] peak appeared for the nickel loaded samples. As an increasing amount of CePO₄ was incorporated into the structure, two CePO₄ phases appear in addition to the CeO₂ and Ni peaks.

BET surface area. BET surface area of the samples was measured using a FlowSorb analyzer from Micremeritics. The surface area of the support increases with the P:Ce ratio in the support, which is in line with the characterization done by Zeng et al. on a similar material. The surface area of the nickel-loaded catalyst samples increases drastically with the addition of phosphorous to the support, and is highest for the sample with a support composition of P:Ce-0.48. Since the EDX results showed that the Ni content of the samples was similar (within 15%), the large increase in surface area may indicate that there are Ni clusters present on top of the support structure that may protrude greatly, which then increase the surface area of the catalyst.

In contrast, the samples with a high P:Ce ratio exhibit high support surface area, and retain a similarly high surface area when loaded with Ni, with little overall change when Ni is added to the support. This may indicate that a high P:Ce ratio is able to integrate small clusters of Ni that are either very small and dispersed, integrated directly into the support crystal structure, and do not protrude greatly from the support.

UV-vis spectroscopy. Optical absorbance was measured using a Lambda 1050 UV-Vis spectrometer equipped with a 150 mm integrating sphere. Catalyst powder samples were loaded onto borosilicate filter paper for measurement.

Laboratory photocatalytic reactor. The laboratory-scale photoreactor used to conduct the experiments presented herein was comprised of a Harrick HTC-3 High Temperature Cell fitted with a fused silica window. The catalyst sample is placed on a steel mesh, underneath which is an electrical resistance heater. The temperature setting of the electrical resistance heater is noted as the “reactor temperature” and does not necessarily represent the catalyst temperature under reaction conditions and when illuminated with light. The catalyst sample was illuminated by an array of four Prizmatix LEDs (UV (UHP-T365-MP), Blue (UHP-T-460-DI), Green (UHP-T-520-DI), and Red (UHP-625-DI)), as well as a beam combiner. The power output of each lamp is able to be modulated independently. The power output for each LED was measured using a power meter at the same position as the sample within the reactor.

Catalyst samples were crushed and sieved to obtain particle sizes ranging from 80 to 20 mesh. Catalyst masses ranging from 1.5 to 2.2 mg were then drop-cast onto a borosilicate fibre disc with a diameter of 0.6 cm, and loaded into the Harrick cell.

For the present examples, a nominal flow rate of 10 mL min−¹ was used, with the reactant feed consisting of equal parts CO₂ and CH₄ (2.5 mL min−¹ each) was used with a balance of 5 mL min-1 Ar. The total conversion of CO₂ and H₂ was below 25% of expected thermal equilibrium conversion. Evolution of reaction products was measured using an in-line SRI 8610c gas chromatograph.

Experimental plan. The study carried out in here first determines the effect of varying support composition on the activity of the catalyst, using thermal measurements to determine an optimum catalyst composition. Following, the temperature and irradiance required to achieve stoichiometric conversion of the reactant products, indicated by observing a 1:1 ratio of H₂ to CO in the product gas mixture. After the reaction conditions for stoichiometric conversion were determined, the wavelength dependence of the samples was explored to determine the wavelength of light that the photocatalyst is most responsive to. Finally, the stability of the catalyst is tested over an 8 hour period.

### Example 3—Photocatalytic Dry Reforming Results

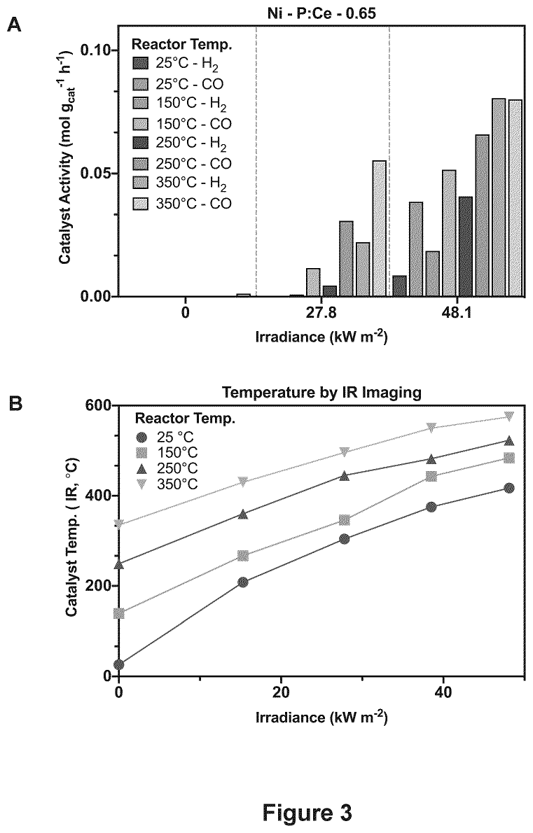

The experiment showed that there exists an critical ratio of P:Ce in the photocatalyst composition that maximizes the photocatalytic activity. FIG. 2 shows the catalytic activity of several Ni—P:Ce-x.xx dry reforming catalysts with varying P:Ce ratios. These tests were done thermally, using no light irradiance. It was determined that there exists an optimal catalyst support composition somewhere between a P:Ce ratio of 0.48 to 0.65. The nickel loading was not optimized. Due to having the highest CO evolution rate, the Ni—P:Ce-0.65 catalyst was chosen for the subsequent photocatalytic tests.

It is postulated that this maximum may be a result of a controllable Ni cluster size that is dependent on the composition of the CeO₂—CePO₄ support. The role that the addition of CePO₄ to the Ni—CeO₂ system may optimize the Ni cluster size, as described above, and may also improve reactant CO₂ adsorption as a result of its increased Lewis basicity. To rule out the possibility of the catalyst activity originating from a nickel-phosphide complex on the surface of the catalyst acting as a reaction centre, a commercial Ni₂P catalyst was tested, however no activity was observed. This indicates that the presence of CeO₂ and CePO₄ together as mixed phases at the surface of the catalyst may play an important role in the reaction mechanism.

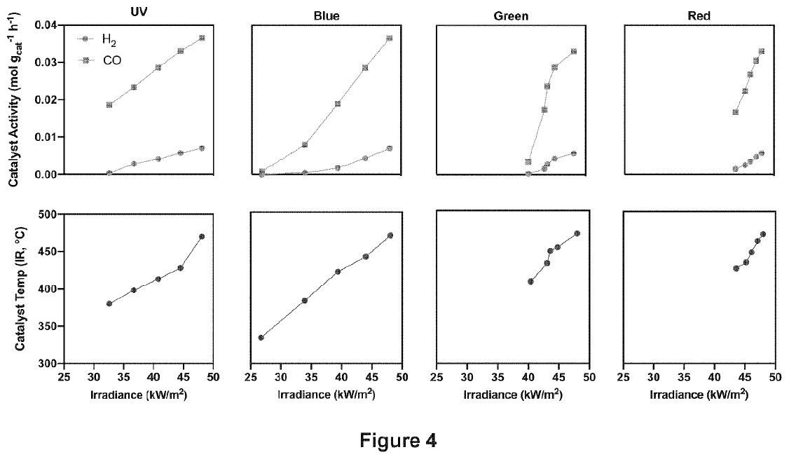

Reaction conditions for high selectivity towards the dry reforming reaction. FIG. 3 shows the measured photocatalytic activity of the Ni—P:Ce-0.65 catalyst under varying reactor temperatures and light irradiance. When no reactor heating is used (ie. 25° C.), the ratio of H₂ to CO in the product is very low, indicating that at those conditions the presence of the RWGS reaction is prevalent, which is typical of the dry reforming reaction system when run at low temperatures. As the temperature increases, the selectivity of the system improves towards the desired dry reforming reaction, and at 350° C. the ratio of H₂ to CO in the product stream is 1.0 implying ideal selectivity for the dry reforming reaction.

Infrared camera imaging of photocatalyst under illumination. In order to investigate the magnitude of heating produced by the illumination of the catalyst with light, infrared thermography using a forward-looking infrared camera (FLIR) was carried out to estimate the global temperature of the catalyst bed when illuminated under different light intensities. A thermal imaging camera (ThermaCAM EC320 FLIR) was directed at the sample while it was being simultaneously irradiated with light. For these measurements, the catalyst sample was placed in the reactor at the focal point of the light, the same approximate distance from the light source as within the reactor. The LEDs were focused onto the sample. Then, the FLIR camera is pointed at the sample to measure the radiated heat caused by the concentrated light.

It is noted that these measurements were not taken in situ, and as a result have some inherent inaccuracies in comparison to the real-world irradiance and temperature increase experienced by the catalyst under reactions conditions. Specifically, the IR camera measurements were taken without the fused silica window in place. Further, there was no gas flow or chemical reaction taking place over the catalyst during IR measurements. Under reaction conditions, the actual surface temperature of the catalyst may be lessened by convective cooling that results from the gas flow over the catalyst, or by the highly endothermic nature of the chemical reaction taking place. As a result, the catalyst temperatures under illumination are likely a high estimate of the surface temperature of the catalyst.

FIG. 3 shows that under the reaction conditions required to produce a 1:1 ratio of H₂ to CO (ie. a reactor temperature of 350° C., and 48.1 kW m−²), the catalyst temperature is measured to rise to 575° C. The measured rise in temperature is likely indicative of a photothermal effect taking place either as a result of non-radiative charge recombination or plasmonic hot carrier relaxation.

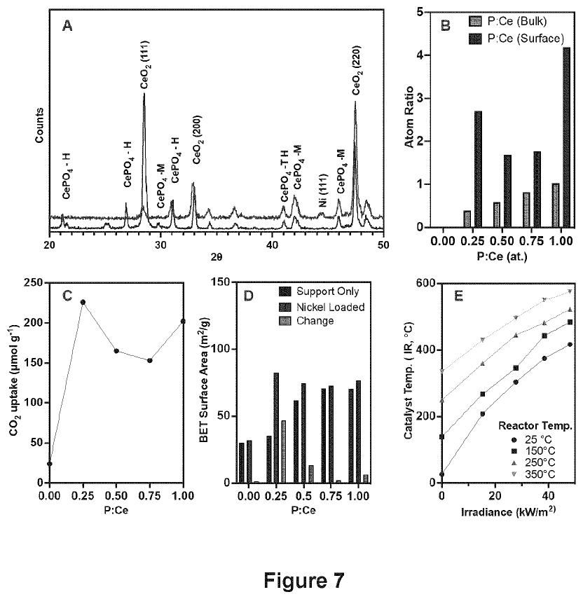

According to the thermodynamic analysis of the dry reforming reaction system, an equilibrium conversion resulting in a 1:1 ratio of H₂ to CO in the product gas mixture is expected to occur for temperatures in excess of 750 to 900° C. (see FIG. 6, panel E). As a result, it is possible that there are photochemical effects present playing a role in the light-induced catalytic mechanism, since the measured increase in catalyst temperature alone is not sufficient to achieve the selectivity required to produce a 1:1 ratio of H₂ to CO in the product gas mixture. Further investigation is required to determine whether there are photochemical mechanisms at play in the Ni—CeO₂CePO₄ dry reforming photocatalytic system.

A hybrid nature of the photocatalytic mechanism is highly likely, with the plasmonic, photothermal, and photochemical centres of the photocatalyst heterostructure working in concert. There are additionally likely interactions between the various mechanisms. For example, the plasmonic Ni centre producing heat may transfer heat to the semiconductor support, therefore changing the band structure of the semiconductor support and therefore its optical properties.

Light intensity and wavelength dependencies. The wavelength dependency of the photocatalyst activity was probed without reactor heating, in order to observe the component of the photoactivity caused by lightinduced mechanisms. For these tests, three of the four LED lamps was held at 100% power, to replicate the reaction conditions that were previously shown to produce a 1:1 ratio of H₂ to CO in the product gas mixture. The fourth LED lamp, representing the light wavelength under examination, was then varied over a range of irradiance.

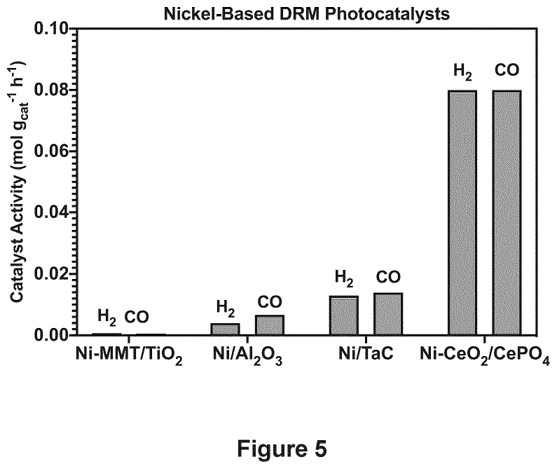

FIG. 4 shows the results for each of these cases, as well as the corresponding catalyst temperature as measured using IR camera imaging. The blue light and green light appear to have a larger impact on the photocatalytic activity, as when they are at 0%, the photocatalytic rate is close to zero, even though the other lamps are at 100%. In contrast, when the red and UV lamps are off, the photocatalytic rate is already significant. This indicates that the catalyst is most active in the blue and UV ranges, which is in line with the findings of the absorption range using UVvis spectroscopy. However, the results show improvement in activity across all the visible spectrum of light. The catalyst temperature increased by the largest amount when the blue light was varied, followed by the UV, green, and red lights. This differed slightly from the increase in rate observed with each wavelength, which increased most as the blue light intensity was increased, followed by the green light, UV, then red.

The type of response displayed by the catalytic activity also varied by wavelength, the different behaviours of which may be indicative of the underlying photocatalytic mechanism at play. The modulation in the intensity of the UV light produced a linear change in the observed reaction rate, whereas changing the intensity of the blue light produced an exponential response, and the change in the green light produced a concave shape. It should be noted that the electronic excitations leading to either photochemical activity or local heating on the catalyst surface occur simultaneously and act synergistically such that the measured activity is not a strict superposition of the two effects, the two effects may not be definitively and quantitatively decoupled without having the loss of their interaction effect affect the effect that the other would display on its own.

It is well known that the temperature dependency of catalytically driven chemical reactions follows an exponential curve, as described by the empirical Arrhenius equation (Equation 1). For an archetypal power-form rate law (Equation 2), this thermal contribution is captured in the rate constant, k. As a result, it follows that an increase in reaction temperature caused by incident light energy will also result in an increased temperature which should follow this exponential trend.

$$k = Ae {-}^{{E}_{a} / RT} \qquad ( 6.1 )$$

$$rco = {kP}_{C α O 2} {P}_{H β 2} \qquad ( 6.2 )$$

In the above equations, k is the rate constant, A is a pre-exponential factor, Ea is the activation energy, R is the gas constant, T is the temperature, r_{CO} is the rate of CO production, P_{CO2} and P_{H2} are the partial pressures of CO₂ and H₂ in the reactant feed, respectively, and a and B are the exponential dependencies of r_{CO} on P_{CO2} and P_{H2} respectively.

In contrast, if an incident photon does not increase the temperature experienced by the system, it is possible that the work done to accomplish the surface chemical reaction is done by the photochemically generated electron-hole pair, or other photon processes. In this scenario, since the absorption of a photon destined to do photochemistry can be assumed to create one electron-hole pair, or a single value of one of the other excited state modes previously described, a linear dependence in reaction rate to radiant flux of photons absorbed by the catalyst is expected. As the system becomes saturated with photon absorption, the reaction rate may taper off, resembling a root law dependency. A combination of the two mechanisms may appear as a supralinear dependency of the reaction rate on radiative flux. By observing the dependence of the reaction rate on the radiative flux of the light, we can distinguish between the two light-assisted catalytic pathways.

As a result, the results shown in FIG. 4 suggest a potential photochemical response in the UV region as a result of the observed linear response to an increase in UV radiative flux. This can be attributed to the absorption of the CeO₂ and CePO₄ phases in the catalyst.

The large increase in catalytic activity rate resulting from an increase of blue light to the catalyst may produce a photothermal response or mixture of a photochemical and photothermal response by virtue of the supralinear or exponential appearance of the catalytic activity response curve. This may be attributed to the shifted absorption peak which above was attributed to a nickel interband transition, which would likely produce heat, resulting in the exponential Arrhenius type response.

The large increase in activity that resulted from an increase in green light irradiation to the catalyst corresponds with the optical absorption peaks that were attributed to the presence of a Ni surface plasmon resonance. This increase in activity is disproportionate to the increase in temperature measured by the catalyst, which may indicate that the LSPR effect has another mechanism in addition to heat production that leads to an increase in catalyst activity. Finally, the concave shape of the curve may indicate a saturation in the effect that green light irradiation has on the catalyst mechanism. This can be true if the Ni LSPR effect is saturated at a critical flux of green photons and there are no available Ni sites to absorb the green photons in addition to this critical flux.

Finally, FIG. 4 also reveals some clues as to the effect that the light has on the overall reaction. The results in FIG. 4 show that when all LEDs are at their maximum intensity, the CO evolution rate is roughly 0.04 mol CO g_{cat}⁻¹ h⁻¹. The thermal-only case shown earlier in FIG. 6.8 showed that at 350° C. with no light present, was just over 0.04 mol CO g_{cat}⁻¹ h⁻¹ as well. These observations are combined in FIG. 3 which shows that at 350° C. and under 48.1 kW cm−² irradiance, the photocatalytic activity is roughly 0.08 mol CO g_{cat}⁻¹ h⁻¹, suggesting that the thermal and photo-induced catalytic activities are additive. The rate of H₂ evolution does not follow this additive nature. Instead, it appears that the combination of light and heat has the effect of changing the selectivity of the reaction to favour the desired dry reforming reaction over the common RWGS side reaction.

Photocatalyst stability. The stability of the Ni—P:Ce-0.65 dry reforming photocatalyst was tested under the reaction conditions which produced a 1:1 ratio of H₂ to CO in the product gas mixture. At these conditions, the photocatalyst showed good stability for 8 h.

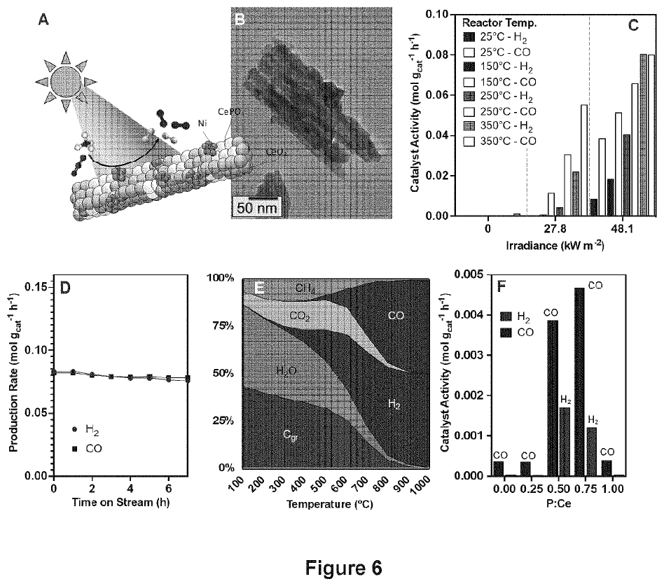

Relative catalyst performance. FIG. 5 shows how the Ni—CeO₂—CePO₄ photocatalyst presented here compares to the other ceria- and nickel-based photocatalysts presented in the academic literature. The Ni—CeO₂—CePO₄ photocatalyst does not outperform the other ceria-based dry reforming photocatalysts presented, which all make use of platinum group metals to boost their activity. However, when compared to the other nickel-based dry reforming catalysts, the activity of the Ni—CeO₂—CePO₄ far outperforms the others. Finally, the activity of the catalyst is in line with the other top catalyst rates as reported in the literature, and meets the minimum requirements for catalyst performance.

Conclusion. It is found that there exists an optimal ratio of P:Ce in the photocatalyst support that maximizes the catalyst's performance towards the dry reforming reaction. This optimum was determined to lie somewhere between a P:Ce ratio of 0.48 to 0.65. It is hypothesized that this optimum is a result of the competing benefits brought to the catalyst by the high oxygen storage capacity CeO₂ component, which is able to oxidize any carbon that may be deposited onto the surface of the photocatalyst, as well as the tuneable surface basicity of the CeO₂—CePO₄ support that depends on the population of Lewis basic PO₄³— at the surface of the catalyst support. The Lewis basic sites have a two-pronged effect of controlling Ni-cluster size, and increasing CO₂ adsorption onto the catalyst. Both of these effects lead to good stability. The controllable size of the Ni clusters on the catalyst support is evidenced by the BET surface area measurements, and optical spectra.

A nickel-loaded sample of the support having a P:Ce ratio of 0.65 was used to determine the photocatalytic performance of the sample. It was found that the NiP:Ce-0.65 photocatalyst sample was able to produce a 1:1 ratio of H₂ to CO in the product gas mixture under a reactor temperature of 350° C. 48.1 KW m−².

Infrared thermography was used to measure the surface temperature of the catalyst. It was found that the temperature of the catalyst can rise to 575° C. under illumination of 48.1 KW m−².

The dependence of the photocatalyst activity on varying wavelengths of light was assessed, and it was determined that the catalyst is most responsive to light in the UV, blue, and green range, as a result of the mixed absorption of the CeO₂, CePO₄, and Ni phases respectively. In addition, the response type of the photocatalyst to a variation in intensity of a certain light wavelength also differed. The exponential increase in the observed catalytic rate with respect to an increase in blue light intensity suggests a primarily photothermal response in the blue spectra. In contrast, the response in rate from an increase in UV light intensity was more linear, suggesting a possible photochemical mechanism.

Finally, the Ni—CeO₂—CePO₄ catalyst was shown to have superior performance in comparison to other nickel-based dry reforming catalysts that have been presented in the literature.

### Example 4—Photocatalyst Mechanism

Stoichiometric conversion indicated by a 1:1 ratio of H₂:CO in the product gas mixture was observed when the Ni—CeO₂—CePO₄ photocatalyst (FIG. 3, panel A) with a P:Ce atom ratio of 0.50 was heated to 350° C. and illuminated with 48.1 kW m 2 white light (FIG. 6, panel C). This represents significantly enhanced activity indicated by a 39.2% reduction in required light intensity and 100° C. thermal temperature reduction in comparison to Ni—CeO₂ DRM photocatalysts demonstrated in the literature which achieved stoichiometric conversion at 450° C. under 79 KW m 2 white light irradiation, while maintaining comparable production rates and high stability (FIG. 6, panel D). Other examples using precious metals have achieved stoichiometric conversion using four times the light intensity (192 KW m 2) that is demonstrated here.

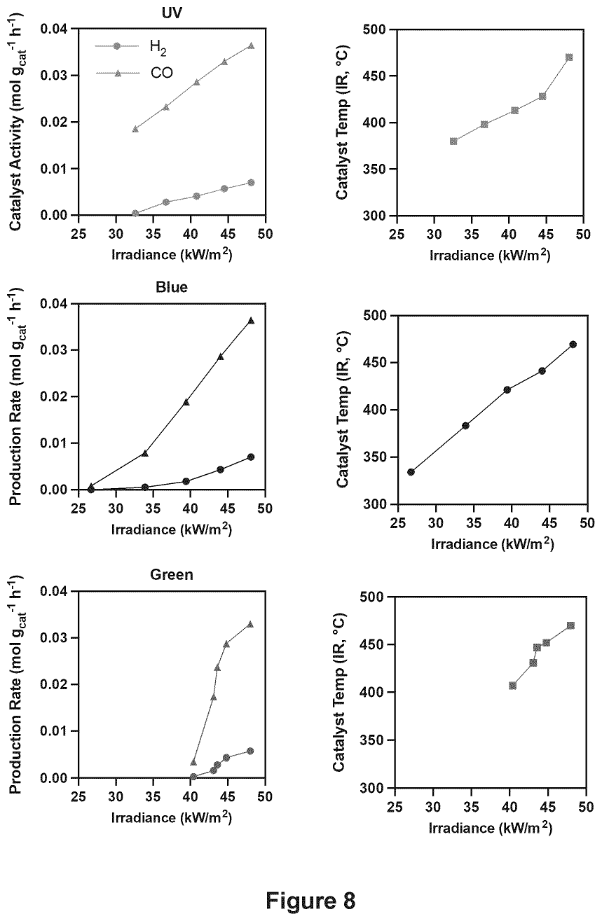

While the stability and selectivity of the Ni—CeO₂—CePO₄ dry reforming photocatalyst is attributed to the cooperative chemical effects of the CeO₂ and CePO₄ components, the high activity is attributed to a novel hybrid photocatalytic mechanism whereby photochemical, photothermal, and plasmonic activity are all present under differing wavelengths of light, and act synergistically to boost activity. While it is common in the academic literature to ascribe photocatalytic activity to one of these mechanisms, it was observed that each are present and contribute to the photocatalytic activity uniquely. Initial evidence for a hybrid photothermal-photochemical-plasmonic mechanism arises from the observation that under a reactor temperature of 350° C., and 48.1 KW m−² the catalyst temperature is measured to rise to 585° C. (FIG. 7, panel E) using ex situ infrared thermography measurements. For thermally driven dry reforming systems, a conversion resulting in a 1:1 ratio of H₂ to CO in the product gas mixture is expected to occur for temperatures above 900° C. As a result, it is possible that there are photochemical effects present playing a role in the light-induced catalytic mechanism, since the measured increase in catalyst temperature alone is not sufficient to achieve the thermal conditions required to produce a 1:1 ratio of H₂ to CO in the product gas mixture.

The photocatalytic mechanism was discerned by probing the wavelength dependence of the photocatalyst activity. The type of response displayed by the catalytic activity in response to increasing irradiance has been noted to be indicative of the underlying photocatalytic mechanism at play. An exponential increase in photocatalytic activity with respect to increased radiative flux is likely due to photothermal effects since an increase in reaction temperature is known to produce this Arrhenius-type kinetics (k=Ae^{(-Ea/RT)}). In contrast, if an incident photon does not increase the temperature experienced by the system, it is possible that the work done to accomplish the surface chemical reaction is done by the photochemically generated electron-hole pair. In this scenario, since the absorption of a photon destined to do photochemistry can be assumed to create one electron-hole pair, or a single value of one of the other excited state modes previously described a more linear dependence in reaction rate to radiant flux of photons absorbed by the catalyst is expected. As photon induced mechanisms become saturated at a high photon flux, the reaction rate may taper off, resembling a root law dependency. A combination of the two mechanisms may appear as a supra-linear dependency of the reaction rate on radiative flux.

The wavelength-dependencies were measured in the absence of reactor heating, using four LED lamps with light spectra confined to a specific segment of the UV- and visible light spectra (UV, blue, red, and green). For these tests, three of the four LED lamps were held at 100% power while the fourth LED lamp, representing the light wavelength under examination, was then varied over a range of irradiances. This allowed for the observation of the change in catalytic activity resulting from an increase in irradiation from that specific wavelength range of light, while considering the interactions that may exist between light induced mechanisms, since electronic excitations leading to either photochemical activity or local heating on the catalyst surface occur simultaneously and act synergistically such that the measured activity is likely not a strict superposition of the two effects, the two effects may not be definitively and quantitatively decoupled without having the loss of their interaction effect affect the effect that the other would display on its own.

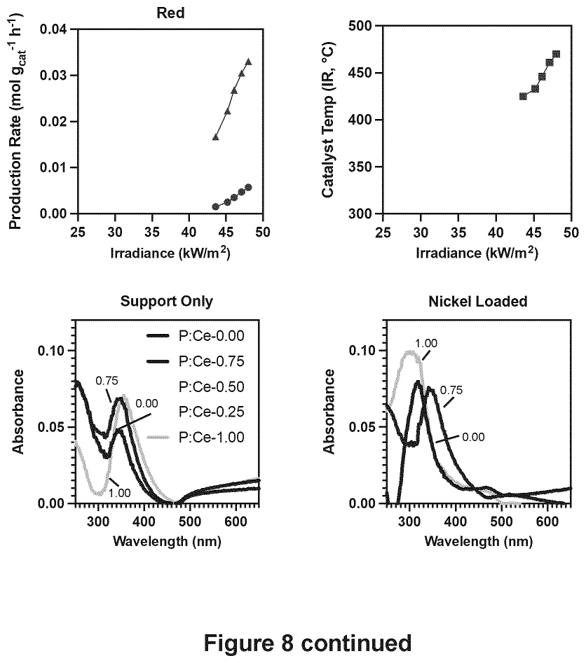

In the results shown in FIG. 8, blue light (425-515 nm) and green light (475-600 nm) appear to have the largest impact on the photocatalytic activity, as when they are at 0%, the photocatalytic rate is very low, despite the other lamps being held at 100%. In contrast, when the red (575-650 nm) and UV (350-425 nm) lamps are off, the photocatalytic rate is already significant. The catalyst temperature increased by the largest amount when the blue light was varied, followed by the UV, green, and red lights. This differed from the increase in rate observed with each wavelength, which increased most as the blue light intensity was increased, followed by the green, UV, then red. This suggests that absorbance in the green region is potentially photochemical in nature since absorbance of green light results in an increased reaction rate in excess to its increase in temperature in comparison to the response of the catalyst in the other wavelength regimes. Further, modulation in the intensity of the UV light produced a linear change in the observed reaction rate, whereas changing the intensity of the blue light produced an exponential response, the change in the green light produced a concave shape, and the change in red light resulted in a linear response, indicating that the nature of the photocatalytic mechanism differs depending on the energy of the photon absorbed. Absorption in the UV region is attributed to the CeO₂—CePO₄ support, as can be seen by the UV-vis spectra in FIG. 8. The absorption peaks for CeO₂ and CePO₄ are similar and have been reported to occur in the range of 280-440 nm. The CeO₂ absorption peak is attributed to an electron transfer from the 02-2p orbital to the Ce⁴⁺ conduction band, while the CePO₄ absorption peak represents the absorption resulting from the ligand-to-metal charge transfer from the phosphate group to the Ce. Given the linear nature of the activity response to an increase in UV radiative flux, it is possible that a photochemical effect is present in this regime, since CeO₂ and CePO₄ are known to exhibit electron-promotion effects upon absorbing UV light. The addition of Ni to the CeO₂—CePO₄ support resulted in a second absorption peak in the optical spectra. Absorbance in the blue region (470-513 nm) can be attributed to a nickel metal interband transition, whereas the broad peak in the green region (500-600 nm) can be attributed to the absorption of Ni that results from the localized surface plasmon resonance (LSPR) that has been reported in the literature. The two effects elicited differing responses in photocatalytic activity. An increase in blue light intensity resulted in an exponential-type response, indicative of a dominant photothermal effect in this region, whereas an increase in green light intensity resulted in an increase in photocatalytic response that appeared to become saturated at a photon flux approaching 50 KW m 2. The response in the green region may be the result of hot-carrier processes, which have been noted to result in a linear response that levels out with saturation.

### Example 5—Additional Analysis

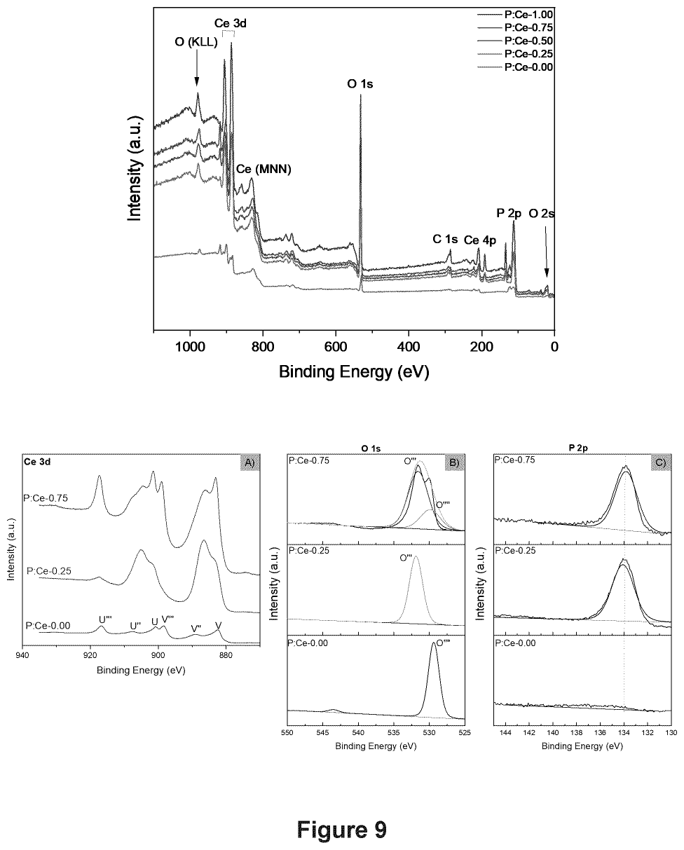

Turning to FIG. 9, a comparison of surface and bulk characterization of the Ni—CeO₂—CePO₄ photocatalyst via XPS and energy-dispersive x-ray spectroscopy (EDX) indicated that the phosphate groups are preferentially segregated to the surface of the catalyst. See also Table 2.

TABLE 2
Identification and quantification of elements from the survey scans.

| | | At. % | | | | |
|---|---|---|---|---|---|---|
| | | P:Ce- | P:Ce- | P:Ce- | P:Ce- | P:Ce- |
| Name | BE (eV) | 0.00 | 0.25 | 0.50 | 0.75 | 1.00 |
| O 1s | 532.08 | 69.43 | 56.44 | 60.99 | 63.66 | 51.40 |
| C 1s | 286.08 | 24.12 | 21.94 | 20.01 | 20.44 | 23.52 |
| Ce 3d | 886.08 | 6.45 | 5.83 | 6.05 | 5.73 | 4.84 |
| P 2p | 134.08 | 0.00 | 15.80 | 10.16 | 10.16 | 20.25 |

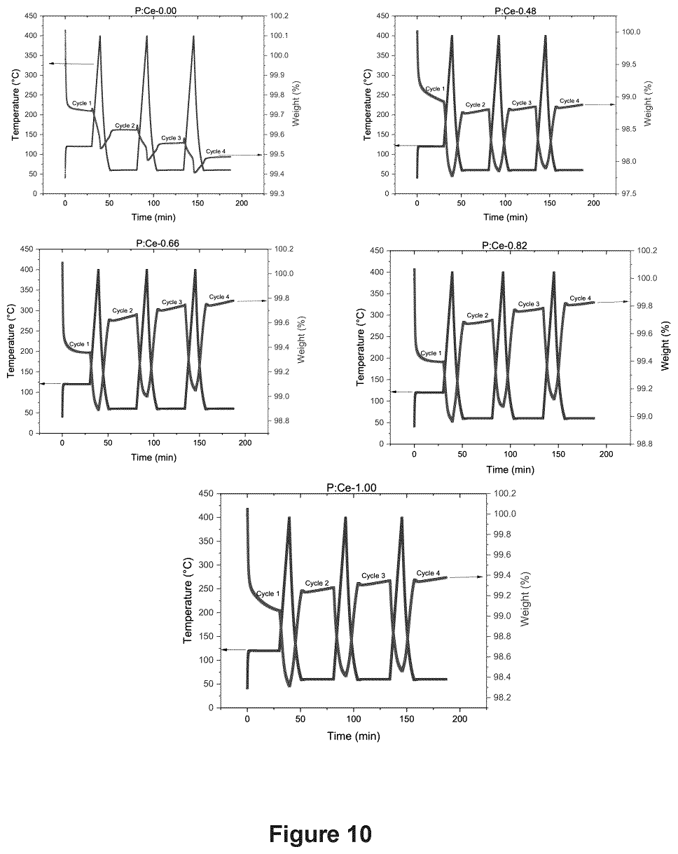

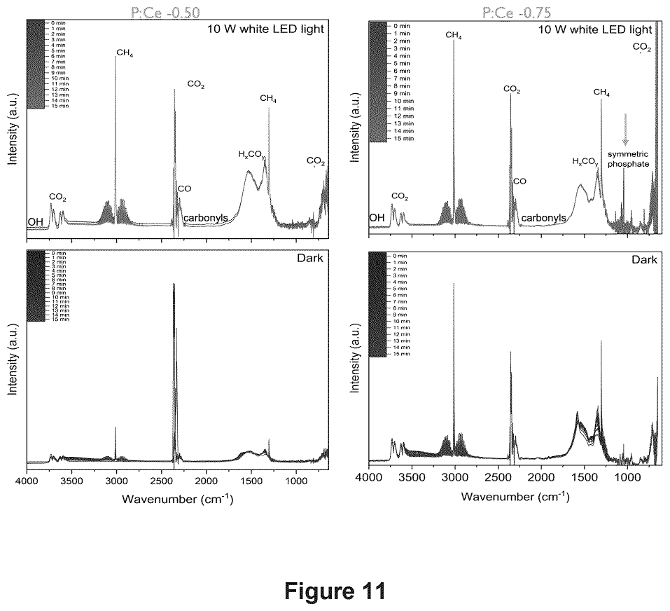

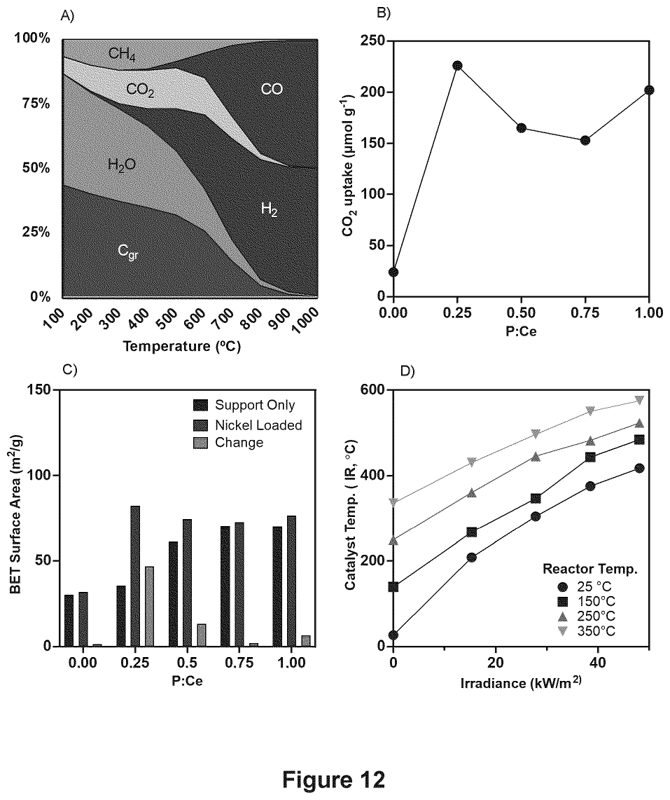

The thermogravimetric analysis are shown in FIG. 10, corresponding to CO₂ update shown in FIG. 11. Turning to FIG. 12, panel A shows that a 1:1 ratio of CO:H₂ in the product mixture should not occur below temperatures of 900 C, while panel C further shows that under the photocatalytic reaction conditions that produce a 1:1 ratio of CO:H₂ in the product gas mixture (350 C+48.1 KW m⁻² irradiation) the temperature of the catalyst reaches just below 600° C., which is an indication that processes in excess of photothermal or “hot” plasmon processes are working to enhance the reaction rate under illumination.

Although the embodiments have been described in detail, it should be understood that various changes, substitutions and alterations can be made herein. Moreover, the scope of the present application is not intended to be limited to the particular embodiments or examples described in the specification. As can be understood, the examples described above and illustrated are intended to be exemplary only.

For example, the present invention contemplates that any of the features shown in any of the embodiments described herein, may be incorporated with any of the features shown in any of the other embodiments described herein, and still fall within the scope of the present invention.

What is claimed is:

1. A photocatalyst composition for catalyzing a dry reforming reaction, wherein the photocatalyst composition is a three-phase heterogeneous catalyst comprising:
a) a support composition comprising a first component and a second component, wherein the first and second components each exhibit photochemical and/or photothermal activity when irradiated; and
b) a plasmonic material disposed on the surface of the support composition and in contact with the support composition.

2. The photocatalyst composition of claim 1, wherein:
a. one of the first and second components is a photochemically active component and the other component is a photothermal component;
b. the first and second components each exhibit both photochemical and photothermal activity; or
c. one of the first and second components exhibits both photochemical and photothermal activity.

3. The photocatalyst composition of claim 1 or 2, wherein the first component is a metal oxide and the second component is a metal phosphate or phosphide, preferably a metal phosphate.

4. The photocatalyst composition of claim 3, wherein the ratio of the metal phosphate or phosphide to the metal oxide is in a range of 0.1 to 0.75.

5. The photocatalyst composition of claim 4, wherein the ratio of the metal phosphate or phosphide to the metal oxide is in a range of 0.48 to 0.65.

6. The photocatalyst composition of claim 4, wherein the ratio of the metal phosphate or phosphide to the metal oxide is about 1:1.

7. The photocatalyst composition of any one of claims 1-6, wherein the first component is a Group 2 metal oxide, or a rare earth metal oxide.

8. The photocatalyst composition of any one of claims 1-6, wherein the first component is MgO, CaO, BaO, La₂O₃, Y₂O₃, ThO₂, CeO₂, ZrO₂, TiO₂, ZnO, SnO₂, In₂O₃, or Bi₂O₃.

9. The photocatalyst composition of claim 8, wherein the first component is MgO, CeO₂, ZrO₂, or In₂O₃.

10. The photocatalyst composition of any one of claims 1-9, wherein the second component is a metal phosphate or phosphide, preferably a Group 2 metal phosphate or phosphide or a rare earth metal phosphate or phosphides, more preferably a Group 2 metal phosphate or rare earth metal phosphate.

11. The photocatalyst composition of any one of claims 1-9, wherein the second component is a magnesium phosphate or phosphide, a calcium phosphate or phosphide, a barium phosphate or phosphide, a lanthanum phosphate or phosphide, a thorium phosphate or phosphide, a cerium phosphate or phosphide, a zirconium phosphate or phosphide, a titanium phosphate or phosphide, a zinc phosphate or phosphide, a tin phosphate or phosphide, or an indium phosphate or phosphide.

12. The photocatalyst composition of claim 11, wherein the second component or the material is Mg₃(PO₄)₂, CePO₄, ZrPO₄ or InPO₄.

13. The photocatalyst composition of any one of claims 1-12, wherein the plasmonic material exhibits photochemical and/or photothermal activity when irradiated.

14. The photocatalyst composition of any one of claims 1-13, wherein the plasmonic material is a Group 8 metal, a Group 11 element, or a noble metal.

15. The photocatalyst composition of claim 14, wherein the plasmonic material is Au, Ag, or Cu.

16. The photocatalyst composition of any one of claims 1-13, wherein the plasmonic material is aluminum, cadmium, chromium, copper, iron, lead, nickel, tin, or zinc.

17. The photocatalyst composition of any one of claims 1-13, wherein the plasmonic material is a metal alloy.

18. The photocatalyst composition of any one of claims 1-13, wherein the plasmonic material is disposed in clusters on the surface of the support composition.

19. The photocatalyst composition of claim 18, wherein the plasmonic material is in clusters of 5-20 nm.

20. The photocatalyst composition of any one of claims 1-19, wherein the plasmonic metal is in mechanical contact with the support composition.

21. The photocatalyst composition of any one of claims 1-19, wherein the plasmonic metal is bonded to the support composition.

22. The photocatalyst composition of claim 1, wherein the first component is CeO₂, the second component is CePO₄, and the plasmonic material is Ni.

23. The photocatalyst composition of claim 1, wherein the first component is MgO, the second component is Mg₃(PO₄)₂, and the plasmonic material is Ni.

24. The photocatalyst composition of claim 1, wherein the first component is In₂O₃, the second component is InPO₄, and the plasmonic material is Ni.

25. The photocatalyst composition of claim 1, wherein the first active component is ZrO₂, the second component is ZrPO₄, and the plasmonic material is Ni.

26. The photocatalyst composition of any one of claims 1-25, having a nanoparticle or nanorod structure.

27. The photocatalyst composition of claim 26, comprising nanorods.

28. The photocatalyst composition of any one of claims 1-27, wherein the photocatalyst composition is manufactured by aqueous-based chemical synthesis, incipient wetness, solid-state syntheses, radiation-dependent syntheses, crystallization, chemical vapor deposition, or physical vapor deposition.

29. A method of performing a dry reforming reaction, the method comprising:
introducing molecular reactants into contact with the photocatalyst composition of any one of claims 1-8; and
irradiating the photocatalyst composition with a light source.

30. The method of claim 29, comprising illuminating the photocatalyst with UV, blue, and/or green light.
